(19) United States
(12) Patent Application Publication
(10) Pub. No.: US 2024/0348041 A1
(43) Pub. Date: Oct. 17, 2024

(54) A CIRCUIT BREAKER

(71) Applicant: EATON INTELLIGENT POWER LIMITED, Dublin (IE)

(72) Inventors: Antonino VESPOLI, Dublin (IE); Daniel ZUCCHETTO, Dublin (IE); Chahrazed BOUHINI, Dublin (IE)

(21) Appl. No.: 18/292,660

(22) PCT Filed: Aug. 2, 2021
(86) PCT No.: PCT/EP2021/071598

§ 371 Date: Jan. 26, 2024

(51) Int. Cl. H02H 3/46; H02H 1/00; H02H 3/38

(52) U.S. Cl. CPC H02H 3/46; H02H 1/0092; H02H 3/38

(57) ABSTRACT

A circuit breaker for controlling a power supply to electrical appliances connected to a power line. The circuit breaker comprises: a signal acquisition module configured to acquire an electrical power signal indicative of the power supply; a circuit breaker mechanism configured to selectively interrupt the power supply to the one or more electrical appliances based on the electrical power signal; an event detection module configured to detect an event associated with operation of one or more of the electrical appliances based on electro-magnetic interference (EMI) generated by the event; and a feedback module configured to control one or more feedback actions in dependence on the detected event. The event detection module is configured to: identify one or more EMI features in the electrical power signal; compare the one or more identified EMI features to an event database comprising event records, and detect the event based on the comparison.

### TECHNICAL FIELD

The present disclosure relates generally to a circuit breaker for controlling a power supply to one or more electrical appliances connected to a power line. Aspects of the disclosure relate to a circuit breaker, to an electricity distribution apparatus and to a method of controlling a power supply to one or more electrical appliances.

### BACKGROUND

Typically, a building includes an electricity distribution apparatus, such as a panel board, configured to distribute a supply of electrical power to the various electrical appliances of the building. The electricity distribution apparatus usually receives electrical power from a local transformer of a power distribution network that connects to the electricity distribution apparatus via a service entrance. In this manner, the service entrance forms a power supply line between the power distribution network and the electricity distribution apparatus.

The electricity distribution apparatus typically includes a plurality of subsidiary circuits, known as branch circuits, arranged in parallel to provide electrical connections to the electrical appliances of the building. For example, each branch circuit may connect to one or more of the electrical appliances and the electricity distribution apparatus may provide circuit breakers, or protective fuses, for controlling the power supply to each branch circuit.

It is common for the electricity distribution apparatus to include a main circuit breaker, upstream of the branch circuits, for providing absolute control over the power supply from the power line to the electrical appliances.

The operation of the electrical appliances creates demand for electrical power, known as an electrical load, and an electricity distribution apparatus is known that includes a plurality of current sensors and voltage sensors for determining the power usage and electrical load of the electrical appliances. For example, it is known to monitor the operation of the electrical appliances in the building using individual branch circuit measurements and to estimate the total power usage of the electrical appliances by aggregating branch circuit power measurements together. A drawback of existing systems for such purposes is that they require sensing equipment to be connected to a socket linked to the power line of interest, which results in an invasive and unwieldy solution. This is particularly the case when the electrical system is divided into many branches, each requiring separate sensing equipment.

It is against this background that the disclosure has been devised.

### SUMMARY OF THE DISCLOSURE

According to an aspect of the present disclosure there is provided a circuit breaker for controlling a power supply to one or more electrical appliances connected to a power line. The circuit breaker comprises: a signal acquisition module configured to acquire an electrical power signal indicative of the power supply; a circuit breaker mechanism configured to selectively interrupt the power supply to the one or more electrical appliances based on the electrical power signal; an event detection module configured to detect an event associated with operation of one or more of the electrical appliances based on electro-magnetic interference (EMI) generated by the event; and a feedback module configured to control one or more feedback actions in dependence on the detected event. The event detection module is configured to: identify one or more EMI features in the acquired electrical power signal; compare the one or more identified EMI features to an event database comprising a plurality of event records, each event record comprising a classified event associated with the operation of one or more of the electrical appliances and one or more EMI features associated with the respective classified event; and detect the event based on the comparison.

Advantageously, the circuit breaker is configured to analyse the electro-magnetic interference (EMI) produced by the operation of the connected electrical appliances to infer events, or operational states, of the connected electrical appliances and to control one or more corresponding feedback actions. The circuit breaker makes advantageous use of the fact that operating an electrical appliance generates EMI on the power supply having frequency characteristics that are largely specific to the circuit design of the electrical appliance, and the particular operation being performed by that appliance. On this basis, features of EMI in the electrical power signal can be identified and compared to the events database of EMI features associated with known, or otherwise classified, events in order to infer the operational states of the electrical appliances. In this manner, the circuit breaker is able to detect when an electrical appliance is switched on or off, as well as more granular operations of the electrical appliance, such as different active states of operation. For example, the circuit breaker may be operated to detect faults, or changes, in the operation of the electrical appliances and to interrupt the power supply accordingly to protect the electrical appliances from a current surge.

The solution is advantageous in that it incorporates components allowing for event detection based on detected EMI into a circuit breaker architecture to provide an architecture with additional/improved functionality. In particular, by incorporating this functionality into a circuit breaker, a simple, compact and non-invasive solution is provided that does not require connections to components to be made via electrical sockets. Furthermore, as previous solutions are connected in parallel (via sockets) with the loads of the electrical system, then these previous solutions are only able to analyse a voltage signal associated with the loads, or a voltage and current of a single load/branch. In contrast, as the present solution incorporates this functionality into a circuit breaker connected in series with the loads, advantageously the current and voltage of each of the loads in the electrical system may be sampled simultaneously, thereby enriching the information provided by the single voltage signal.

It shall be appreciated that the circuit breaker is configured to detect the event in the sense of either matching the event to a classified event in the events database or otherwise identifying the event as an unclassified event.

Accordingly, the event detection module may, for example, be configured to: identify that the detected event is a respective classified event if the one or more identified EMI features correspond to the one or more EMI features associated with the respective classified event; and/or identify that the detected event is an unclassified event if the one or more identified EMI features do not correspond to the one or more EMI features associated with any one of the classified events in the plurality of event records.

In an example, the feedback module may be configured to determine the one or more feedback actions to control based on the identification of the detected event. In particular, the feedback module may be configured to determine the one or more feedback actions to control as corresponding feedback actions associated with, or otherwise based on, the respective classified event identified. Such feedback actions may be included in the respective event records or otherwise determined as suitable actions for the respective operations of the electrical appliances. Where the detected event is identified as an unclassified event, the feedback module may be configured to determine one or more feedback actions that are non-specific to the operation of the electrical appliances but generally suitable for an unclassified event.

Optionally, the one or more feedback actions determined by the feedback module for a respective classified event comprise controlling the circuit breaker mechanism to interrupt the power supply to the one or more electrical appliances.

In an example, the one or more feedback actions determined by the feedback module for an unclassified event may comprise generating a new event record for the event database.

In an example, acquiring the electrical power signal may comprise receiving a measurement signal indicative of a current, and/or a voltage, of the power supply.

Optionally, acquiring the electrical power signal may comprise applying a high-pass filter to the received measurement signal to obtain an EMI portion of the measurement signal. Acquiring the electrical power signal may, for example, further comprise amplifying the determined EMI portion of the measurement signal. Optionally, the signal acquisition module may be further configured to apply a low-pass filter to the received measurement signal to obtain a low-frequency portion of the measurement signal. The event detection module may be configured to analyse the low-frequency portion of the measurement signal to identify one or more low-frequency features of the electrical power signal that may be indicative of low-frequency variations of the power supply. The event detection module may be further configured to detect the event based, at least in part, on the one or more identified low-frequency features.

In an example, the event detection module comprises a signal processing module configured to determine the one or more EMI features based on one or more frequency characteristics of the electrical power signal.

For example, the signal processing module may be configured to decompose the electrical power signal into one or more EMI frequency components. The decomposition may, for example, be performed using a Fast-Fourier transform.

Optionally, the signal processing module is configured to determine each EMI feature as a set of parameters representative of a respective EMI frequency component. For example, the signal processing module may be configured to determine each set of parameters by modelling the EMI frequency components as Gaussian features.

In an example, the signal processing module may be configured to apply a machine learning algorithm to determine the one or more EMI features based on the frequency characteristics of the electrical power signal.

In an example, the circuit breaker may further comprise a data augmentation module configured to generate one or more augmented EMI features, associated with the detected event, based on the one or more EMI features. The augmented EMI features form different variations of the identified EMI feature(s) that are associated with the detected event. For example, each augmented EMI feature may provide augmented values of the Gaussian features. The data augmentation module may include one or more algorithms for generating the one or more augmented EMI features in the form of variations, derived from known EMI features, representing similar frequency characteristics, for example with variations that may be considered relatively minor in a noisy environment.

In an example, the data augmentation module may include a Generative Adversarial Network for generating the one or more augmented EMI features.

Optionally, the one or more feedback actions determined by the feedback module for a respective classified event may comprise: controlling the data augmentation module to generate the one or more augmented EMI features; and updating the one or more EMI features associated with the respective classified event, in the respective event record, to further include the one or more augmented EMI features. In this manner, the future coverage of the detected event may be enhanced, iteratively improving the events system.

In an example, the circuit breaker may further comprise a communication module connectable to the one or more electrical appliances, and/or to one or more external servers.

Optionally, the one or more feedback actions determined by the feedback module for a respective classified event may comprise transmitting, via the communications module, a warning signal to the one or more electrical appliances. The warning signal may, for example, be transmitted to the electrical appliances associated with the detected event.

Optionally, the one or more feedback actions determined by the feedback module for an unclassified event may comprise: transmitting the one or more identified EMI features to the one or more external servers, via the communications module, for offline processing. The offline processing may, for example, lead to the generation of a new event record comprising a classified event and the one or more identified EMI features, which may be received at the communications module and/or added to the events database.

According to another aspect of the disclosure, there is provided an electrical distribution apparatus for connection to a power line supplying electrical power to one or more electrical appliances in a building, the electrical distribution apparatus comprising a circuit breaker as described in a previous aspect.

According to a further aspect of the disclosure, there is provided a method of controlling a power supply to one or more electrical appliances connected to a power line using a circuit breaker as described in a previous aspect, or an electrical distribution apparatus as described in another aspect. The method comprises: acquiring an electrical power signal indicative of the power supply; selectively operating the circuit breaker mechanism to interrupt the power supply to the one or more electrical appliances based on the electrical power signal; detecting an event associated with operation of one or more of the electrical appliances based on electro-magnetic interference (EMI) generated by the event; and controlling one or more feedback actions in dependence on the detected event. Detecting the event comprises: identifying one or more EMI features in the electrical power signal; comparing the one or more identified EMI features to an event database comprising a plurality of event records, each event record comprising a classified event associated with the operation of one or more of the electrical appliances and one or more EMI features associated with the respective classified event; and detecting the event based on the comparison.

According to another aspect of the disclosure there is provided a non-transitory, computer-readable storage medium storing instructions thereon that when executed by a processor causes the processor to perform a method described in another aspect of the disclosure.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 shows a simplified schematic view of an electrical circuit that is formed by an electricity distribution apparatus used to distribute a supply of electrical power to a plurality of electrical appliances in a building;

FIG. 2 shows a schematic view of an exemplary circuit breaker of the electricity distribution apparatus shown in FIG. 1;

FIG. 3 shows the steps of an example method for controlling the power supply to the plurality of electrical appliances in FIG. 1;

FIG. 4 shows exemplary sub-steps of the method shown in FIG. 3;

FIG. 5 shows further exemplary sub-steps of the method shown in FIG. 3;

FIG. 6 shows the steps of another example method for controlling the power supply to the plurality of electrical appliances in FIG. 1;

FIG. 7 shows a schematic view of another exemplary circuit breaker of the electricity distribution apparatus shown in FIG. 1; and

FIG. 8 shows the steps of a further example method for controlling the power supply to the plurality of electrical appliances in FIG. 1.

### DETAILED DESCRIPTION

Embodiments of the disclosure relate to a circuit breaker, and to a method, for controlling a power supply to one or more electrical appliances. Advantageously, the circuit breaker is configured to detect various events associated with the operation of the connected electrical appliances and to determine one or more feedback actions to perform based on the event detection. For example, upon detecting a fault, or a change in operation, of one of the electrical appliances, the circuit breaker may interrupt the power supply to protect the electrical appliances from a current surge.

Advantageously, the circuit breaker is configured to perform such event detection by analysing the electro-magnetic interference (EMI) that is detectable in the power supply. In particular, the operation of an electrical appliance is known to generate EMI, which adds distinctive, high-frequency, noise components to current, and/or voltage measurements, of the power supply. For context, the EMI is typically a high-frequency in the order of kHz or MHz, whilst the grid frequency is typically at a low-frequency, around 50 Hz or 60 Hz for example.

The EMI is largely specific to the circuit design of the electrical appliance, and the particular operation being performed by that appliance, producing recognisable features of EMI that are stable and repeatable across different households, and electrical circuits.

The circuit breaker is advantageously configured to make use of this effect to infer operational states of the connected electrical appliances. More specifically, the circuit breaker is configured to analyse the frequency characteristics of the current, and/or the voltage, of the power supply in order to identify EMI features of the power supply. The circuit breaker then compares the identified EMI features to a database of known, or classified, electrical appliance operations, and associated EMI features, in order to detect respective operations of the electrical appliances. In this manner, the circuit breaker is able to detect when a lamp is switched on or off, as well as more granular operations, such as a dimmer setting of the lamp. The circuit breaker uses the detected event to determine one or more suitable feedback actions, such as interrupting the power supply or issuing power warnings to respective electrical appliances.

It is anticipated that the circuit breaker will lead to a reduction in the cost of instrumentation and enhanced control of the power supply to the electrical appliances, providing more detailed event detection and thereby facilitating additional safety measures.

The circuit breaker shall now be discussed in more detail with reference to an example application in a simple exemplary electrical circuit.

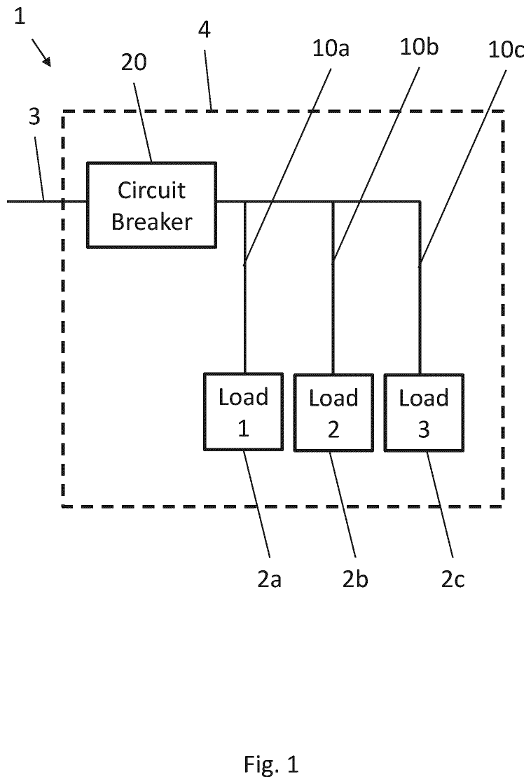

FIG. 1 schematically illustrates an example electrical circuit 1 for supplying electrical power to a plurality of electrical appliances 2a-c of a building. The electrical circuit 1 features a power line 3 and an electrical distribution apparatus 4, through which the power line 3 is connected to the plurality of electrical appliances 2a-c.

The power line 3 provides an electrical power supply to the electrical appliances 2a-c of the building and may, for example, take the form of a supply line from a power distribution network or power grid. Accordingly, in this example, the power supply comprises an alternating current and an alternating voltage at a grid frequency associated with the connected grid or power distribution network. The grid frequency may typically be a frequency of 50 Hz or 60 Hz, for example.

Electrical power supply from a power distribution network is typically subject to grid fluctuations that may cause the power supply frequency to increase and/or decrease within a permissible range, for example by up to 5%. However, for the sake of simplicity, it is assumed that the grid frequency is substantially constant in the following description.

The electricity distribution apparatus 4 is configured to distribute the electrical power supply to the electrical appliances 2a-c and may, for example, take the form of a panel board.

The electricity distribution apparatus 4 comprises a plurality of branch circuits 10a-c, arranged in parallel, that connect to the electrical appliances 2a-c of the building. For the sake of simplicity, the plurality of branch circuits 10a-c includes a first branch circuit 10a, a second branch circuit 10b and a third branch circuit 10c, in this example. Furthermore, each branch circuit 10a-c, in this example, connects to a respective electrical appliance 2a-c of the building, represented in FIG. 1 by an electrical load.

It shall be appreciated that the example electricity distribution apparatus 4 is not intended to be limiting on the scope of the disclosure though and, in other examples, the electricity distribution apparatus 4 may include any number of branch circuits and each branch circuit may connect to one or more electrical appliances that form respective electrical loads.

The electricity distribution apparatus 4 is shown to include a circuit breaker 20, which may, for example, take the form of an energy management circuit breaker. In this example, the circuit breaker 20 is connected to the power line 3, upstream of the branch circuits 10a-c, and acts as a main circuit breaker for providing absolute control of the electrical power supply to the electrical appliances 2a-c.

Although not shown, it shall be appreciated that, the electrical distribution apparatus 4 may include one or more further circuit breakers, that may be substantially identical to the circuit breaker 20. For example, one or more further circuit breakers may be arranged in respective branch circuits of the electricity distribution apparatus for controlling the power supply therethrough to the electrical appliances of each branch circuit.

As shall be made clear in the following description, the circuit breaker 20 is configured to monitor the electro-magnetic interference (EMI) in the power supply, and to detect various events associated with the operation of the connected electrical appliances 2a-c on that basis. The circuit breaker 20 is also configured to control one or more feedback actions, such as interrupting the power supply to the electrical appliances 2a-c, in dependence on the detected events.

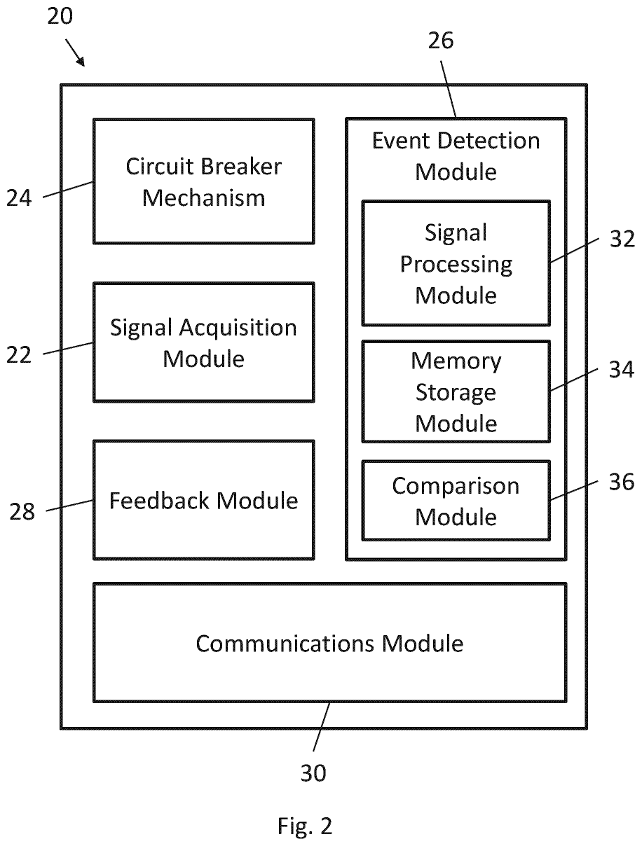

The circuit breaker 20 shall now be considered in more detail with reference to FIG. 2, which illustrates a non-limiting example of the circuit breaker 20.

As shown in FIG. 2, the circuit breaker 20 may include a signal acquisition module 22, a circuit breaker mechanism 24, an event detection module 26, a feedback module 28 and a communications module 30.

That is, in the described example five functional elements, units or modules are shown. Each of these units or modules may be provided, at least in part, by suitable software running on any suitable computing substrate using conventional or customer processors and memory. Some or all of the units or modules may use a common computing substrate (for example, they may run on the same server) or separate substrates, or different combinations of the modules may be distributed between multiple computing devices.

The signal acquisition module 22 is configured to determine an electrical power signal indicative of the power supply to the electrical appliances 2a-c. For this purpose, the signal acquisition module 22 may comprise, or connect to, one or more sensors (not shown) configured to measure the current, and/or the voltage, of the power supply. For example, the signal acquisition module 22 may include a current sensor for measuring the current of the power supply and a voltage sensor for measuring the voltage of the power supply. The current sensor and the voltage sensor may connect to the power line 3 upstream of the branch circuits 2a-c to allow sampling of the current and voltage of all the electrical appliances 2a-c simultaneously.

In an example, the signal acquisition module 22 may be configured to determine the electrical power signal by measuring the current, and/or the voltage, of the power supply, and by performing one or more further signal preparation operations on the measurement signals.

For example, the signal acquisition module 22 may be further configured to isolate an electro-magnetic interference portion of the measured current, and/or the measured voltage. For this purpose, the signal acquisition module 22 may include a high-pass filter for determining an electro-magnetic interference portion of each measurement signal. The high-pass filter may be configured to attenuate the portion of each measurement signal having a frequency lower than an EMI cut-off frequency. The EMI cut-off frequency may, for example, correspond to the grid frequency of the connected grid or distribution network. For example, the EMI-cut off frequency may be a frequency of at least 50 Hz, and preferably at least 60 Hz. In an example, the EMI cut-off frequency may be a frequency of at least 1 kHz.

It shall be appreciated that the signal acquisition module 22 may also include one or more amplifiers (not shown) for amplifying the measurement signals, and/or one or more analogue to digital converters (not shown) for converting the measurement signals into digital signals. Furthermore, the signal acquisition module 22 may be configured to perform the further signal preparation operations, described above, in voltage form. For this purpose, the signal acquisition module 22 may also include a current to voltage converter (not shown), for converting the current measurement signal to voltage form, and an isolation buffer (not shown) for the voltage measurement signal, to protect the circuit before the further signal preparation operations are performed.

The circuit breaker mechanism 24 is operable to selectively interrupt the power supply to the electrical appliances 2a-c. As shall be described in more detail, the circuit breaker mechanism 24 may be configured to selectively interrupt the power supply to the electrical appliances 2a-c based on the determined electrical power signal and, particularly, in response to detecting certain events associated with the operation of the electrical appliances 2a-c. Accordingly, the circuit breaker mechanism 24 may include a mechanical or electrical switch (not shown) for interrupting the electrical power supply and a controller (not shown) for operating the switch.

The event detection module 26 is configured to detect events associated with the operation of one or more of the electrical appliances 2a-c based on the electro-magnetic interference (EMI) generated by the operations of the electrical appliances 2a-c. For the purpose of detecting such events, the event detection module 26 may include a signal processing module 32, a memory storage module 34, and a comparison module 36, as shown in FIG. 2.

The signal processing module 32 is configured to analyse the frequency characteristics of the electrical power signal, and thereby to identify one or more electro-magnetic interference features (EMI features) of the electrical power signal. As discussed above, the EMI generated by the operation of an electrical device is largely specific to the circuit design of the electrical appliance, and the particular operation being performed by that appliance. Hence, each electrical device operation will repeatedly generate largely consistent, and therefore recognisable, features of EMI. Such EMI features can be characterised by various parameters including, for example, a set of Gaussian features, which may include values of an average frequency, an amplitude, and a standard deviation of the EMI.

The signal processing module 32 may therefore be configured to use one or more methods for analysing the frequency characteristics of the electrical power signal and identifying the EMI feature(s). To give an example, the signal processing module 32 may be configured to determine the EMI feature(s) by decomposing the electrical power signal into one or more EMI frequency components. For example, the signal processing module 32 may use a transform function, such as a Fast Fourier Transform, and model the EMI frequency component(s) as Gaussian features, thereby decomposing the electrical power signal. The signal processing module 32 may also apply other functions, such as a windowing function, to the electrical power signal, prior to using the transform function, to mitigate spectral leakage caused by discontinuities in the electrical power signal. For example, the signal processing module 32 may apply a scrolling window average with a window size that is configured to minimise false positives, whilst being able to adequately detect separate events.

To give another example, the signal processing module 32 may be configured to use one or more machine learning algorithms, and/or feature extraction techniques, to identify the EMI features. In this context, convolutional layer networks may be used for the purposes of determining the EMI features, as shall be appreciated by the skilled person.

The memory storage module 34 comprises a database of known, or classified, electrical appliance operations and associated EMI features for comparison to the identified EMI features. In particular, the database, referred to as an events database, comprises a plurality of event records. Each event record comprises a classified event and one or more EMI features associated with that event. In this context, a classified event is an event associated with a respective operation of one or more electrical appliances, where the EMI features generated by that operation have been determined allowing the event to be subsequently recognised and therefore labelled. For the purposes of allowing the circuit breaker 20 to perform suitable feedback actions, each event record may also comprise one or more associated feedback actions for the control breaker 20 to undertake in case that event is detected.

The event records may relate to events previously detected by the event detection module 26, which are stored in the memory storage module 34, and/or event records otherwise received at the memory storage module 34, for example from an external server or network. The events database may therefore be limited to classified events associated with the operation of the electrical appliances 2a-c connected to the circuit breaker 20 or the events database may extend to further include classified events associated with the operation of other electrical appliances, not connected to the circuit breaker 20.

As shall be described in more detail, the memory storage module 34 may interact with the communications module 30 of the circuit breaker 20, which may connect to one or more external servers for providing updates, corrections, or additions to the events database. For example, the communications module 30 may connect to external servers that are operable to perform offline analysis, i.e. independent of the operation of the circuit breaker 20, of the electrical appliances 2a-c, their operations, and/or the associated EMI features. It is envisaged that such offline analysis will allow for detected events to be classified, as well as the generation, or refinement, of associated EMI features, and/or the determination of corresponding feedback actions for the circuit breaker 20 to take in response to a detected event. In this manner, the external servers may be operated to generate new event records, and/or to update existing event records.

For the purpose of receiving and/or storing such data, the memory storage module 34 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The comparison module 36 is configured to compare the one or more identified EMI features to the event database and to effectively detect the event based on the comparison.

In particular, where the identified EMI features match, or otherwise correspond to, the one or more EMI features associated with one of the classified events in the events database, the comparison module 36 may thereby detect that event and label the identified EMI features accordingly. However, where the identified EMI features do not match, or otherwise correspond to, the one or more EMI features associated with any one of the classified events, the comparison module 36 may be configured to detect an unclassified event instead.

It shall be appreciated that the comparison module 36 may perform such comparisons using one or more methods known in the art for comparing frequency characteristics of a current, or voltage, measurement signal. Such comparison methods will depend on the format of the identified EMI features and so are not described in detail here to avoid obscuring the disclosure.

The feedback module 28 is configured to control one or more feedback actions in dependence on the event detected by the comparison module 36. In particular, upon detecting a classified event, the feedback module 28 may be configured to receive the event record associated with the classified event and to execute the corresponding feedback actions, stored in the event record, which may be provided as a set of computer readable instructions for execution by the feedback module 28.

The feedback actions may include sending a control signal to operate the control breaker mechanism 22 to interrupt the power supply to the electrical devices 2a-c, sending a signal to one or more of the electrical appliances 2a-c (for example to suspend an operation of the electrical device), as well as other notifications, such as sending a notification to a user smartphone or a technician via the communications module 30. To give an example, upon detecting a classified event that is known to present a safety hazard, the feedback module 28 may enact the corresponding feedback action to operate the control breaker mechanism 22 to interrupt the power supply.

Upon receiving an unclassified event, the feedback module 28 may be configured to generate a new event record for the event database based on the unclassified event, and/or to communicate the unclassified event (and the identified EMI features) to an external server or network for offline analysis, for example via the communications module 30. The offline analysis may thereby allow for further analysis of the event and determination of corresponding feedback actions to take in dependence on detecting such event again. In this manner, the event database may be updated with new event records, with updated EMI features for the event records, or with updated feedback actions to take.

The communications module 30 is configured to connect to one or more external servers, and/or the electrical appliances 2a-c, for the purposes of executing the feedback actions and/or updating the events database. For this purpose, the communications module 30 may, for example, include a wireless communication module configured to form a wireless connection to an external server or wireless network. The communications module 30 may therefore facilitate the offline analysis of events and provide a means for updating the events database.

For purposes of this disclosure, it is to be understood that the functional elements, units and modules described herein may each comprise a control unit or computational device having one or more electronic processors. A set of instructions could be provided which, when executed, cause said control unit(s) to implement the control techniques described herein (including the described method(s)). The set of instructions may be embedded in one or more electronic processors, or alternatively, the set of instructions could be provided as software to be executed by one or more electronic processor(s). The set of instructions may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

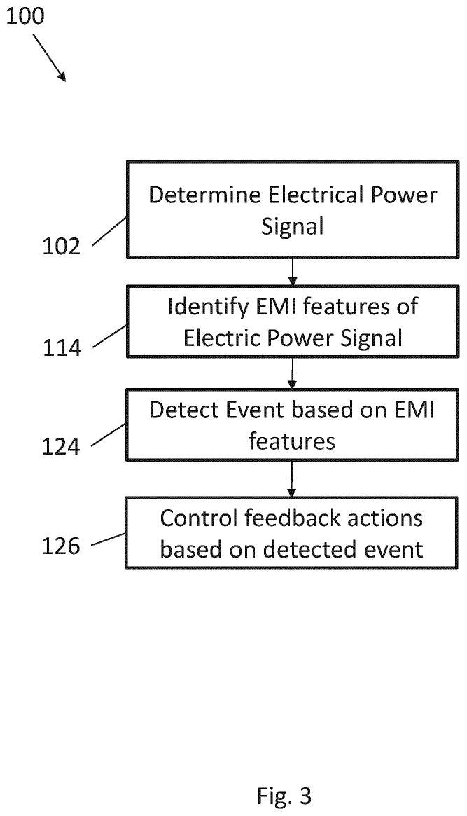

The operation of the circuit breaker 20 in the example electrical circuit 1 shall now be described with additional reference to FIGS. 3 to 5.

FIG. 3 shows an example method 100 of operating the circuit breaker 20 to control the power supply to the electrical appliances 2a-c, in accordance with an embodiment of the disclosure.

In step 102, the circuit breaker 20 is configured to monitor the power supply to the electrical appliances 2a-c and to determine an electrical power signal indicative of the power supply.

The signal acquisition module 22 of the circuit breaker 20 may, for example, be configured to determine the electrical power signal in a digital form that may be suitable for the subsequent event detection in step 114. Furthermore, for efficient processing, the signal acquisition module 22 may be determined in a form that is indicative of the EMI portion of the current, and/or the voltage, of the power supply.

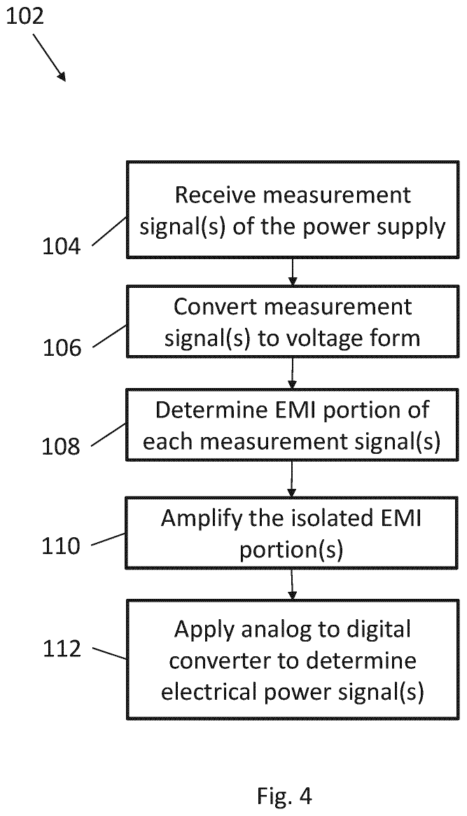

FIG. 4 shows example sub-steps 104 to 112 of the step 102 for determining the electrical power signal, in accordance with an embodiment of the disclosure.

In sub-step 104, the signal acquisition module 22 may receive measurement signals of the current, and/or the voltage, of the power supply from one or more sensors connected to the power line 3 and the signal acquisition module 22.

In this example, the signal acquisition module 22 receives both current and voltage measurement signals and so, in sub-step 106, the signal acquisition module 22 converts the measured current signal to voltage form using the current to voltage converter. In order protect the electrical circuit 3, the signal acquisition module 22 also buffers the measured voltage signal using the isolation buffer, while the measured current signal is converted to voltage form.

Once the measured current and the measured voltage signals are in voltage form, subsequent signal preparation operations can be performed in parallel for the voltage and the current measurement signals, and the further processing is identical.

In sub-step 108, the signal acquisition module 22 isolates the EMI portion from each measurement signal to facilitate more efficient identification of the EMI features in step 114. In particular, in sub-step 108, the signal acquisition module 22 applies the high-pass filter to the measurements signals to determine the EMI portions of the current, and the voltage, measurement signals, i.e. determining the portions of the current and voltage measurement signals having a frequency above the EMI-cut-off frequency, which may be a frequency of 60 Hz for example.

In sub-step 110, the signal acquisition module 22 is configured to amplify the isolated EMI portions of the measurement signals and, in sub-step 112, the signal acquisition module 22 applies the analog to digital converter to sample the amplified EMI portions at a high frequency (in the order of MHZ) and thereby to convert the amplified EMI portions into digital electrical power signals that are indicative of the electrical power supply and suitable for the subsequent event detection.

Returning to FIG. 3, in step 114, the circuit breaker 20 is configured to analyse the frequency characteristics of the electrical power signals to identify one or more EMI features.

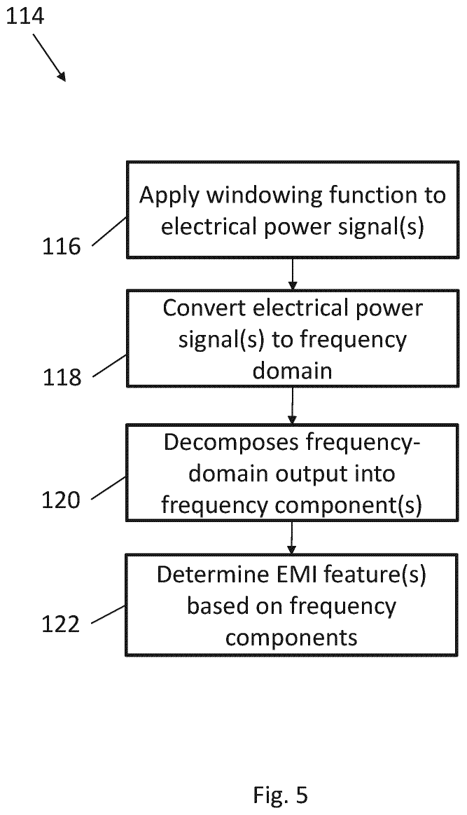

As mentioned previously, the circuit breaker 20 may use one or more methods for the purposes of identifying the EMI features. However, for the sake of clarity, FIG. 5 provides, non-limiting, exemplary sub-steps 116 to 122 for identifying the EMI features by decomposing the electrical power signals, determined in step 102, into EMI frequency components, in accordance with an embodiment of the disclosure.

In sub-step 116, the event detection module 26 is configured to receive the electrical power signals, determined in step 102, and to apply a windowing function to each electrical power signal to reduce spectral leakage. In particular, the signal processing module 30 may apply a scrolling window average of a pre-determined number, N, of the most recent samples acquired in sub-step 112. To give an example, the pre-determined number, N, may be approximately 25 to provide a window size that is configured to minimise false positives, whilst being able to adequately detect separate events.

In sub-step 118, the event detection module 26 applies a transform function to the electrical power signal windows output from the windowing function, to convert the current and voltage measurements into the frequency-domain. For example, the signal processing module 30 may apply a Fast Fourier Transform (FFT) function to each electrical power signal.

The different frequency components of the current and the voltage of the electrical power supply can be analysed more effectively in the frequency domain.

In sub-step 120, the event detection module 26 decomposes the frequency-domain output of the transform function into one or more frequency components. For example, in sub-step 120, the event detection module 26 may apply a function modelling each frequency-domain output as a sum of Gaussian functions, each having the parameters: amplitude (A), average frequency (u), and standard deviation (o).

It shall be appreciated that it is suitable to model the frequency-domain outputs as a sum of Gaussian functions for the purposes of identifying the EMI features as the EMI associated with a particular operation of an electrical appliance reliably forms characteristic noise at a respective frequency that is largely specific to the circuitry of the electrical appliance and the operation being performed.

Accordingly, once decomposed into the frequency component(s), the event detection module 26 may therefore determine the EMI features of the electrical power signal, in sub-step 122, as respective triplets containing the parameters of each Gaussian function, for example as: [(A1, μ1, σ1) . . . (An, μn, σn)].

In this form, the EMI features are suitable for comparison to the events database for the purpose of inferring the operation of the electrical appliances 2a-c, as shall now be described with further reference to FIG. 3.

In step 124, the circuit breaker 20 is configured to compare the EMI features identified in step 114 to the event database and, based on that comparison, to detect any events associated with the operation of the electrical appliances 2a-c.

For example, the comparison module 34 may be operated to access the memory storage module 34 and to compare the EMI feature(s), identified in step 114, to the EMI features of each event record in the events database.

Continuing the previous example, it shall be appreciated that each event record may include a classified event associated with the operation of one or more electrical appliances and one or more EMI features, that may also be defined by a comparable set of Gaussian parameters.

Hence, in step 124, the comparison module 34 may therefore apply one or more comparison functions for comparing the Gaussian parameters of each of the EMI feature(s) identified in step 114 to the Gaussian parameters of the EMI feature(s) of each event record.

Where the identified EMI features match, or otherwise demonstrate sufficient correspondence to the EMI features of a respective one of the event records, the event detection module 26 may identify the respective classified event and/or label the identified EMI feature(s) according to the respective classified event. It shall be appreciated that the identified EMI features may demonstrate sufficient correspondence to the EMI features of one of the event records where they match within a prescribed error tolerance, for example.

Where the identified EMI features do not match the EMI features of any of the event records, the event detection module 26 may identify an unclassified event and/or label the identified EMI feature(s) as an unclassified event.

In step 126, the circuit breaker 20 is configured to determine one or more feedback actions to perform based on the event detected in step 124.

In particular, in step 126, the feedback module 28 of the circuit breaker 20 may receive the detected event and determine a corresponding to feedback action to take. For example, where the detected event was labelled as a classified event, the feedback module 28 may receive, or otherwise access, the corresponding feedback actions stored with said event in the respective event record and process such feedback action(s) to perform a suitable action to address the event. Such feedback actions may, for example, include operating the circuit breaker mechanism 24 to interrupt the power supply to the electrical appliances, and/or sending a control signal to one or more of the electrical appliances 2a-c via the communications module 30.

To give an example, where the detected event is a classified event that is known to present a major hazard for humans and/or the electrical machines 2a-c, the corresponding feedback actions may include operating the circuit breaker mechanism 24 to interrupt the power supply to the electrical appliances 2a-c and communicating a warning to the devices connected via the communications module 32.

In contrast, where the detected event is a classified event that is known to only present a minor hazard, the corresponding feedbacks actions may be limited to communicating a warning to the devices connected via the communications module 32.

It is envisaged that the feedback actions may therefore be used to control the power supply to the electrical appliances 2a-c before a major issue appears, safeguarding the safe operating condition of the electrical appliances 2a-c, and preventing hazards.

Where the detected event was labelled as an unclassified event in step 124, the feedback module 28 may be configured to generate a new event record, based on the unclassified event and the identified EMI feature(s), for addition to the events database.

For this purpose, the feedback module 28 may operate the communications module 30 to send the unclassified event and the identified EMI feature(s) to an external server for further analysis offline. Such offline analysis may serve to further analyse the event and to determine corresponding feedback action(s) to take in response to such an event. The external server may then return a new event record, to be added to the events database, in which the event is suitably classified along with the EMI features and the corresponding feedback actions.

As a result of the method 100, it is envisaged that the EMI of an electrical appliance can be analysed to detect degradation in performance and even imminent failure of the appliance. The circuit breaker 20 can leverage these insights and prevent hazards by interrupting the power supply to the electrical appliance under risk.

It is noted that the steps of the method 100 are only provided as a non-limiting example of the disclosure though and many modifications may be made to the above-described examples without departing from the scope of the appended claims.

In another example, the signal acquisition module 22 of the circuit breaker 20 may also include a low-pass filter (not shown) for acquiring data about the low-frequency variations of the power supply. For example, the circuit breaker 20 may be configured to process the low-frequency portion of the measured current, and/or the measured voltage, for load identification purposes, amongst other uses that are known in the art. The low-pass filter is configured to generate a low-frequency portion of each measurement signal by attenuating the portion of the measurement signal having a frequency greater than a low-frequency cut-off. The low-frequency cut-off may, for example, correspond to the grid frequency, and/or to the EMI cut-off frequency. For example, the low-frequency cut-off may be less than a frequency of 1 MHZ, preferably less than 1 kHz, more preferably leas than, or equal, to 60 HZ, and the low-frequency cut-off may even be less than, or equal to, 50 Hz.

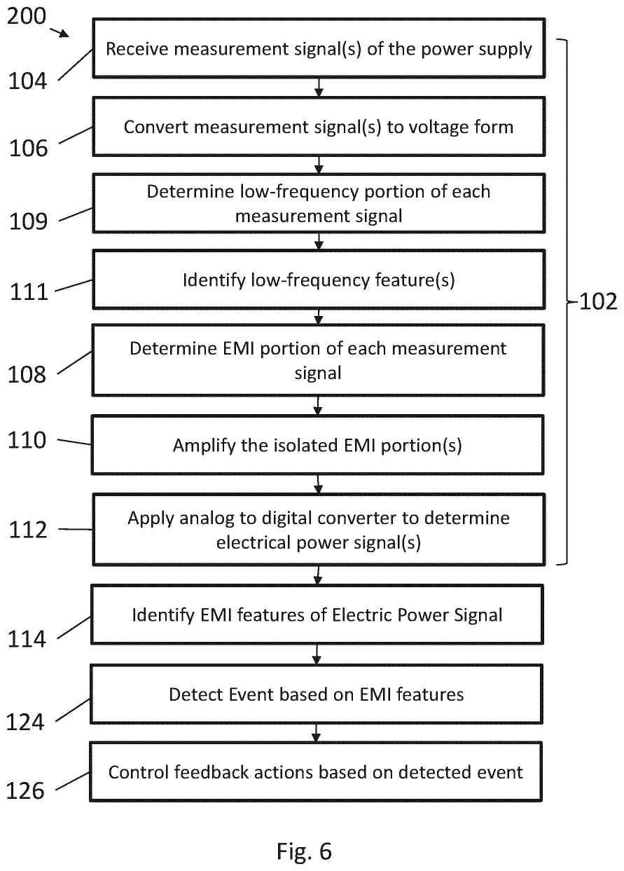

Accordingly, a further example method 200 of operating the circuit breaker 20 to control the power supply to the electrical appliances 2a-c, in accordance with an embodiment of the disclosure, is shown in FIG. 6.

The method 200 proceeds through the steps 102 to 126 substantially as described previously in the example method 100, shown in FIG. 3. However, in the method 200, the circuit breaker 20 is further configured to determine the low-frequency portion of each measurement signal, in sub-step 109, to acquire data about the low-frequency variations of the measured current, and/or the measured voltage.

For example, having received the measurement signals, in sub-step 104, and converted the measurement signals to voltage form, in sub-step 106, the signal acquisition module 22 may be configured to apply the low-pass filter to the measurements signals to determine the low-frequency portions of the measurement signals, in sub-step 109. For example, the signal acquisition module 22 may therefore determine the portions of the measured current and the measured voltage signals having a frequency less than, or equal to, a frequency of 60 Hz.

In contrast to the EMI portions of the measurement signals, determined in sub-step 108, the signal acquisition module 22 may send the low-frequency portions of the measurement signals directly to the event detection module 26 for analysis of the frequency characteristics, in sub-step 111.

In particular, in sub-step 111, the event detection module 26 may receive the low frequency portions and apply one or more known methods of analysing low-frequency power characteristics to identify one or more features that are indicative of the operation of the electrical appliances 2a-c. Such low-frequency features may, for example, include features that are indicative of a load change event at one of the electrical appliances 2a-c. The low-frequency analysis methods are well-known in the art and are not described in detail here to avoid obscuring the disclosure.

Having identified the low-frequency feature(s) of the power supply, the circuit breaker 20 may be configured to use the low-frequency feature(s) either alone, or in combination with the identified EMI feature(s), to provide enhanced event detection and/or to determine one or more feedback actions.

For example, one or more event records in the events database may comprise one or more low-frequency features, i.e. features of the low-frequency portion of an electrical power signal, that are associated with the classified event. Such event records may include the one or more low-frequency features in addition to, or as an alternative to, the EMI features associated with the classified event. In this manner, the low-frequency features may be used independently, or in combination with the EMI features, to detect events.

Accordingly, in step 124 of the method 200, the event detection module 26 may be configured to detect an event by comparing the low-frequency feature(s), identified in step 111, with the low-frequency features of the event records in addition to, or as an alternative to, comparing the EMI features, identified in sub-step 122, to the EMI features of the event records, substantially as described previously. The combined processing of low-frequency and high-frequency components may be used to increase the accuracy of the analysis, leveraging the same infrastructure in a more efficient manner than using two different devices to acquire the data.

Accordingly, the feedback module 28 may be configured to determine one or more feedback actions based at least in part on the identified low-frequency feature(s), substantially as described in step 126.

Furthermore, upon detecting an unclassified event, in step 124, the feedback module 28 may be configured to store the identified low-frequency feature(s) with the identified EMI feature(s) in the events database, and/or to transmit the identified low-frequency feature(s) to one or more external servers for offline analysis, for example via the communications module 30.

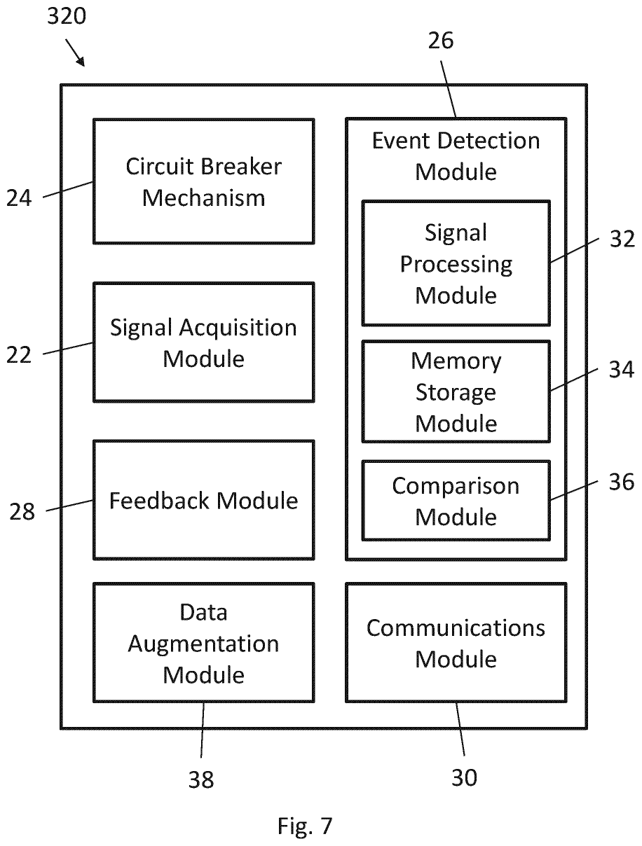

Another example circuit breaker 320, in accordance with an embodiment of the disclosure, is shown in FIG. 7. The circuit breaker 320 is substantially as described previously in the example circuit breaker 20, shown in FIG. 1.

In the example shown in FIG. 7, the circuit breaker 320 further comprises a data augmentation module 38 configured to generate one or more augmented EMI features, associated with the detected event, based on the one or more identified EMI features. The augmented EMI features form different variations of the identified EMI feature(s) that are associated with the same classified event. For example, each augmented EMI feature may provide augmented values of an average frequency, an amplitude, and a standard deviation of EMI associated with the detected event.

For this purpose, the data augmentation module 38 may include one or more algorithms, such as Generative Adversarial Networks (GANs), for generating suitable augmented data in the form of variations, derived from known or previously recorded EMI features, that represent similar frequency characteristics, for example with variations that may be considered relatively minor when matched or considered in a noisy environment. For context, GANs are widely used to generate more variation samples of data from the same input sample. The GANs approach relies on using two neural networks, the generator and discriminator, both acting in the same way used for game theory. The generative networks can be used to generate augmented EMI features from learned characteristics of the identified EMI features. The discriminator, instead, evaluates the augmented EMI features and tries to distinguish the augmented EMI features from the identified EMI features. The aim of the system is to have the generator fooling the discriminator while generating augmented EMI features with an increasing difference from the identified EMI features. In this way, the discriminator will better learn how to successfully recognize the identified EMI features.

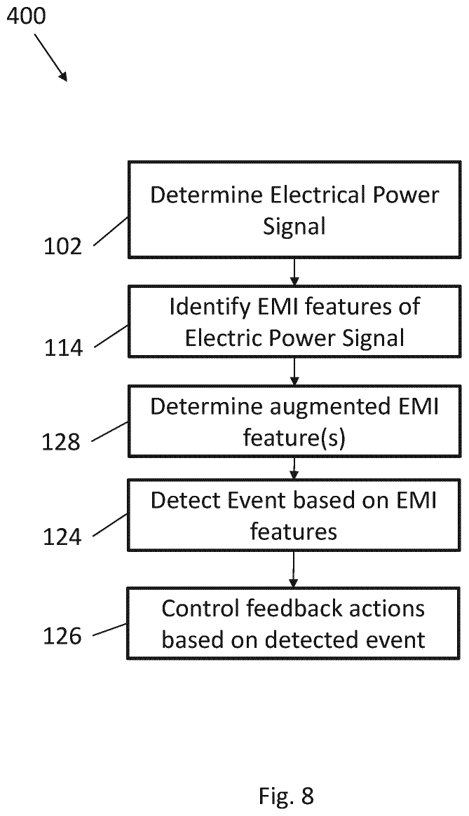

Accordingly, a further example method 400 of operating the circuit breaker 20 to control the power supply to the electrical appliances 2a-c, in accordance with an embodiment of the disclosure, is shown in FIG. 8.

The method 400 may be substantially as described in any of the previous example methods 100, 200. However, the method 400 further includes the step 128 of generating one or more augmented EMI features. In particular, the data augmentation module 38 may be configured to receive the identified EMI features, in step 114, and to determine one or more augmented EMI features based thereon.

The data augmentation module 38 may, for example, use the Generative Adversarial Networks (GANs) to generate augmented EMI features as similar variations of the identified EMI features.

In an example, the comparison module 36 may use the augmented EMI features in addition to the identified EMI features, in step 114, for comparison to the events database to provide enhanced match verification and event detection.

Furthermore, in dependence on detecting a classified event, the augmented EMI features, generated in step 128, may be used to update the matched event record as a feedback action in step 126.

Additionally, or alternatively, in dependence on detecting an unclassified event, the augmented EMI features may be used, in addition to the identified EMI features, to generate a new event record as a feedback action in step 126.

In an example, the data augmentation module 38 may be configured to only generate the one or more augmented EMI features, as described, in dependence on detecting the classified event.

It shall also be appreciated that, in other examples, the circuit breaker 20 may be connected to the power line 3 as part of a panel board, as described in the examples above, or as part of any other electricity distribution apparatus, or even as a standalone component.

1. A circuit breaker for controlling a power supply to one or more electrical appliances connected to a power line, the circuit breaker comprising:
a signal acquisition module configured to acquire an electrical power signal indicative of the power supply;
a circuit breaker mechanism configured to selectively interrupt the power supply to the one or more electrical appliances based on the electrical power signal;
an event detection module configured to detect an event associated with operation of one or more of the electrical appliances based on electro-magnetic interference (EMI) generated by the event; and,
a feedback module configured to control one or more feedback actions in dependence on the detected event;
wherein the event detection module is configured to:
identify one or more EMI features in the acquired electrical power signal;
compare the one or more identified EMI features to an event database comprising a plurality of event records, each event record comprising a classified event associated with the operation of one or more of the electrical appliances and one or more EMI features associated with the respective classified event; and,
detect the event based on the comparison.

2. A circuit breaker according to claim 1, wherein the event detection module is configured to:
identify that the detected event is a respective classified event if the one or more identified EMI features correspond to the one or more EMI features associated with the respective classified event; and/or
identify that the detected event is an unclassified event if the one or more identified EMI features do not correspond to the one or more EMI features associated with any one of the classified events in the plurality of event records.

3. A circuit breaker according to claim 2, wherein the feedback module is configured to determine the one or more feedback actions to control based on the identification of the detected event.

4. A circuit breaker according to claim 3, wherein the one or more feedback actions determined by the feedback module for a respective classified event comprise at least one among:
controlling the circuit breaker mechanism to interrupt the power supply to the one or more electrical appliances; and
generating a new event record for the event database.

5-23. (canceled)

24. A circuit breaker according to claim 1, wherein acquiring the electrical power signal comprises receiving a measurement signal indicative of a current, and/or a voltage, of the power supply.

25. A circuit breaker according to claim 24, wherein acquiring the electrical power signal comprises applying a high-pass filter to the received measurement signal to obtain an EMI portion of the measurement signal, and wherein acquiring the electrical power signal comprises amplifying the determined EMI portion of the measurement signal.

26. A circuit breaker according to claim 1, wherein the event detection module comprises a signal processing module configured to determine the one or more EMI features based on one or more frequency characteristics of the electrical power signal.

27. A circuit breaker according to claim 26, wherein the signal processing module is configured to decompose the electrical power signal into one or more EMI frequency components.

28. A circuit breaker according to claim 27, wherein the signal processing module is configured to determine each EMI feature as a set of parameters representative of a respective EMI frequency component.

29. A circuit breaker according to claim 28, wherein the signal processing module is configured to determine each set of parameters by modelling the EMI frequency components as Gaussian features.

30. A circuit breaker according to claim 26, wherein the signal processing module is configured to apply a machine learning algorithm to determine the one or more EMI features based on the frequency characteristics of the electrical power signal.

31. A circuit breaker according to claim 1, further comprising a data augmentation module configured to generate one or more augmented EMI features, associated with the detected event, based on the one or more EMI features.

32. A circuit breaker according to claim 31, wherein the data augmentation module includes a Generative Adversarial Network for generating the one or more augmented EMI features.

33. A circuit breaker according to claim 31, wherein the one or more feedback actions determined by the feedback module for a respective classified event comprise controlling the circuit breaker mechanism to interrupt the power supply to the one or more electrical appliances; and wherein the one or more feedback actions determined by the feedback module for a respective classified event comprise:
controlling the data augmentation module to generate the one or more augmented EMI features; and,
updating the one or more EMI features associated with the respective classified event, in the respective event record, to further include the one or more augmented EMI features.

34. A circuit breaker according to claim 1, further comprising a communication module connectable to the one or more electrical appliances, and/or to one or more external servers.

35. A circuit breaker according to claim 34, wherein the one or more feedback actions determined by the feedback module for a respective classified event comprise controlling the circuit breaker mechanism to interrupt the power supply to the one or more electrical appliances; and wherein the one or more feedback actions determined by the feedback module for a respective classified event comprise transmitting, via the communications module, a warning signal to the one or more electrical appliances.

36. A circuit breaker according to claim 34, wherein the one or more feedback actions determined by the feedback module for a respective classified event comprise controlling the circuit breaker mechanism to interrupt the power supply to the one or more electrical appliances; and wherein the one or more feedback actions determined by the feedback module for an unclassified event comprise transmitting the one or more identified EMI features to the one or more external servers, via the communications module, for offline processing.

37. An electrical distribution apparatus for connection to a power line supplying electrical power to one or more electrical appliances in a building, the electrical distribution apparatus comprising a circuit breaker according to claim 1.

38. A method of controlling a power supply to one or more electrical appliances connected to a power line using a circuit breaker according to claim 1, or an electrical distribution apparatus for connection to a power line supplying electrical power to one or more electrical appliances in a building, the electrical distribution apparatus comprising said circuit breaker, the method comprising:
acquiring an electrical power signal indicative of the power supply;
selectively operating the circuit breaker mechanism to interrupt the power supply to the one or more electrical appliances based on the electrical power signal;
detecting an event associated with operation of one or more of the electrical appliances based on electro-magnetic interference (EMI) generated by the event; and,
controlling one or more feedback actions in dependence on the detected event;
wherein detecting the event comprises:
identifying one or more EMI features in the acquired electrical power signal;
comparing the one or more identified EMI features to an event database comprising a plurality of event records, each event record comprising a classified event associated with the operation of one or more of the electrical appliances and one or more EMI features associated with the respective classified event; and,
detecting the event based on the comparison.

39. A non-transitory, computer-readable storage medium having instructions stored thereon that, when executed by a computer processor, cause the computer processor to carry out the method of claim 38.
